(19) United States
(12) Patent Application Publication
(10) Pub. No.: US 2026/0025021 A1
(43) Pub. Date: Jan. 22, 2026

(54) PROVIDING MAINTENANCE CHARGING TO A BATTERY

(71) Applicant: Cummins Power Generation Inc., Minneapolis, MN (US)

(72) Inventors: Ikenna Oguguo, Canterbury (GB); Leo Steffl, Plymouth, MN (US); Mike James Scheuerell, Stillwater, MN (US)

(73) Assignee: Cummins Power Generation Inc., Minneapolis, MN (US)

(21) Appl. No.: 18/994,372

(22) PCT Filed: Jul. 14, 2023
(86) PCT No.: PCT/US2023/027829

§ 371 Date: Jan. 14, 2025

Related U.S. Application Data
(60) Provisional application No. 63/390,242, filed on Jul. 18, 2022.

(51) Int. Cl. H02J 7/00; H02J 3/32; H02J 3/38; H02J 7/02

(52) U.S. Cl. CPC H02J 7/0069; H02J 3/32; H02J 3/381; H02J 7/0047; H02J 7/0063; H02J 7/0068; H02J 7/02; H02J 2207/20

(57) ABSTRACT

A mobile power source system with maintenance charging and a method of maintenance charging the mobile power source system are disclosed. In one aspect, the mobile power source system includes a bidirectional inverter electrically connected to the battery and configured to convert an alternating current (AC) power to direct current (DC) power in a first direction and convert DC power to AC power in a second direction. The system also includes a first switch configured to provide grid power from an electrical grid to the bidirectional inverter when switched on and stop providing the grid power to the bidirectional inverter when switched off. The system further includes a second switch configured to provide battery power from the bidirectional inverter to a load when switched on and stop providing the battery power to the load when switched off.

### CROSS-REFERENCE TO RELATED PATENT APPLICATIONS

This application claims priority to U.S. Patent Application No. 63/390,242, filed on Jul. 18, 2022, the entirety of which is incorporated by reference herein.

### TECHNICAL FIELD

The present disclosure generally relates to providing maintenance charging for a battery.

### BACKGROUND

Power generators are a mobile power source that can be configured for a variety of purposes. For example, in operation, power generators are configured to meet a variety of design requirements including weight and noise limits, power and cooling performance efficiency, and electromagnetic, temperature, and structural resiliency. Changing consumer demands and increased fuel supply chain constraints have led to a demand for mobile power generators utilizing renewable power sources. Further, as mobile power generators are designed to meet stricter operating requirements and consumer demands, mobile power generators also continue to efficiently cool electronic components therein to prevent overheating and/or damage to electronic components.

Power generators are sometimes connected to batteries so that the unused energy generated by the power generators can be stored for future use. Batteries in general can self-discharge over time even if no load is being powered because of natural chemical reactions within the batteries. If the batteries are in storage and are not routinely recharged for long periods of time, the batteries can be discharged to low levels such that there is not enough charge to power a load when needed.

### SUMMARY

In one aspect, a mobile power source system configured to provide maintenance charging to a battery is disclosed. The mobile power source system includes a bidirectional inverter electrically connected to the battery and configured to convert an alternating current (AC) power to direct current (DC) power in a first direction and convert DC power to AC power in a second direction, a first switch configured to provide grid power from an electrical grid to the bidirectional inverter when switched on and stop providing the grid power to the bidirectional inverter when switched off, a second switch configured to provide battery power from the bidirectional inverter to a load when switched on and stop providing the battery power to the load when switched off, and a controller configured to control the first switch and the second switch.

In some embodiments, the mobile power source system further includes an electrical plug configured to connect with an electrical outlet and a sensor configured to sense whether the electrical plug is receiving the grid power when the electrical plug is connected to the electrical outlet.

In some embodiments, when the sensor detects the grid power, the controller is configured to switch the first switch on and switch the second switch off.

In some embodiments, the mobile power source system further includes a first electronics packaging assembly that includes the bidirectional inverter, wherein the bidirectional inverter is configured to convert the grid power in the first direction.

In some embodiments, when the sensor does not sense the grid power, the controller is further configured to switch the first switch off and switch the second switch on.

In some embodiments, the mobile power source system further includes a power generator configured to provide power to the battery or the load.

In some embodiments, the mobile power source system further includes a renewable power source configured to convert a renewable resource to renewable power and provide renewable power to the battery or the load.

In some embodiments, the mobile power source system includes a chassis and a trailer configured to move the mobile power source system from one location to another.

In some embodiments, the mobile power source system is configured to mitigate electromagnetic interference.

Another aspect is a method of a mobile power source system for providing maintenance charging to a battery. The method includes determining, by a controller, whether shore power is available. The method further includes, based on a determination that the shore power is available, turning on, by the controller, a first switch connected to an outlet providing the shore power and a bidirectional inverter. The method further includes based on a determination associated with availability of the shore power, turning off, by the controller, a second switch connected to the bidirectional inverter and the first switch. The method further includes converting, by the bidirectional inverter, the shore power from alternating current (AC) power to direct current (DC) power. The method further includes storing, by the bidirectional inverter, the DC power in the battery.

In some embodiments, the method includes based on a determination that the shore power is available, preventing, by the controller, the load from drawing power from the battery.

In some embodiments, the method includes sensing at least one of a voltage, a current amount, or a frequency associated with the shore power when determining, by the controller, whether the shore power is available.

In some embodiments, the method includes performing the sensing, turning on, turning off, converting, and storing steps when the mobile power source system is in storage or in transit.

Another aspect is a controller of a mobile power source system for providing maintenance charging to a battery when the battery is in storage or in transit, the mobile power source controller comprising a processor configured to determine whether grid power is available, based on a determination associated with availability of the grid power, turn on a first switch connected to an outlet providing the grid power and a bidirectional inverter, based on a determination associated with availability of the grid power, turn off a second switch connected to the bidirectional AC-DC inverter and the first switch, convert the grid power from alternating current (AC) power to direct current (DC) power, and store the DC power in the battery.

In some embodiments, the controller is configured to operate under fluctuating temperatures ranging from −31.7° C. to 51.7° C.

In some embodiments, the controller is configured to operate below a predetermined noise level corresponding to an audible threshold.

In some embodiments, the processor is configured to control a first electronics packaging assembly configured to support a first amount of power and a second electronics packaging assembly configured to support a second amount of power, such that the mobile power source controller supports a sum of the first amount of power and the second amount of power.

In some embodiments, the processor is configured to connect the first electronics packaging assembly and the second electronics packaging assembly via a network.

In some embodiments, the processor is configured to control a first electronic packaging assembly to control a first switch, control a second electronic packaging assembly to control a second switch, and control a third electronic packaging assembly to control a third switch.

In some embodiments, the processor is configured to control a switch connected to a power source to provide power to a load.

### BRIEF DESCRIPTION OF THE DRAWINGS

The disclosure will become more fully understood from the following detailed description, taken in conjunction with the accompanying FIGs., wherein like reference numerals refer to like elements unless otherwise indicated, in which:

FIG. 1 illustrates a perspective view of a mobile power source system including an electronics packaging assembly, in accordance with some embodiments.

FIG. 2 illustrates a block diagram of the mobile power source system including the electronics packaging assembly, in accordance with some embodiments.

FIG. 3 illustrates a block diagram of an example of the mobile power source system including the electronics packaging assembly, in accordance with some embodiments.

FIG. 4 illustrates a block diagram of a portion of an example of the mobile power source system for providing maintenance charging to the energy storage system, in accordance with some embodiments.

FIG. 5 illustrates a flowchart illustrating a method of providing maintenance charging to the batteries in the mobile power source system, in accordance with some embodiments.

### DETAILED DESCRIPTION

Following below are more detailed descriptions of various concepts related to, and implementations of, systems, methods, and controllers for providing maintenance charging to batteries. The various concepts introduced above and discussed in greater detail below can be implemented in any of a number of ways, as the described concepts are not limited to any particular manner of implementation. Examples of specific implementations and applications are provided primarily for illustrative purposes.

The present disclosure relates to techniques of providing maintenance charging to a battery. For example, a bidirectional inverter connected to a battery can be used for maintenance charging of the battery. In some embodiments, a first switch can be used to provide power from an electrical grid to the bidirectional inverter when switched on and stop providing the power when switched off. In some embodiments, a second switch can be used to provide power from the bidirectional inverter to a load when switched on and stop providing the power to the load when switched off. In some embodiments, a controller can be used to control the first switch and the second switch.

In various implementations, the bidirectional inverters in electrical packaging assemblies can be used with minimal modification to the software and/or electrical controls. In some implementations, no hardware modification needs to be made. Rather than using an external maintenance charger to charge the batteries, by modifying the controls of the existing controller, the need for additional components can be eliminated, in some implementations, saving costs and weight, and reducing additional points of potential failure.

Various embodiments disclosed herein provide for at least one exemplary embodiment of a power generator system including a battery management system configured to facilitate maintenance charging. As explained in more detail herein, in some embodiments, the battery management system can include a bidirectional inverter (e.g., acts as an inverter in one direction and a rectifier in the opposite direction) that can be leveraged for maintenance charging of batteries. Such exemplary embodiments are advantageous as they can avoid the need for extra parts such as external maintenance chargers that add to additional costs and weight to the power generator systems. Further, modifying the controls of the battery management system to leverage the existing bidirectional inverter, rather than adding additional hardware, can reduce unnecessary possible points of failure.

According to some example embodiments described herein, maintenance charging can be provided to a mobile power source system (e.g., mobile power generator systems) without the need for additional equipment. The mobile power source system can be trailer mounted. In various embodiments, the features of this disclosure may be applied in a variety of applications such as military, recreational vehicle, etc. An electric plug can be plugged into an AC power outlet in, for example, a storage facility that provides a standard 120V, 60 Hz AC power (in the U.S.). The existing bidirectional inverter, which can be used to charge the battery with power from the power generator and/or the renewable power source and also power the load from the battery, can be used to convert the AC grid power (or shore power) to DC power. The DC power output from the inverter can charge the battery. Various embodiments can provide cost savings, weight savings, and fewer failures due to fewer points of failure.

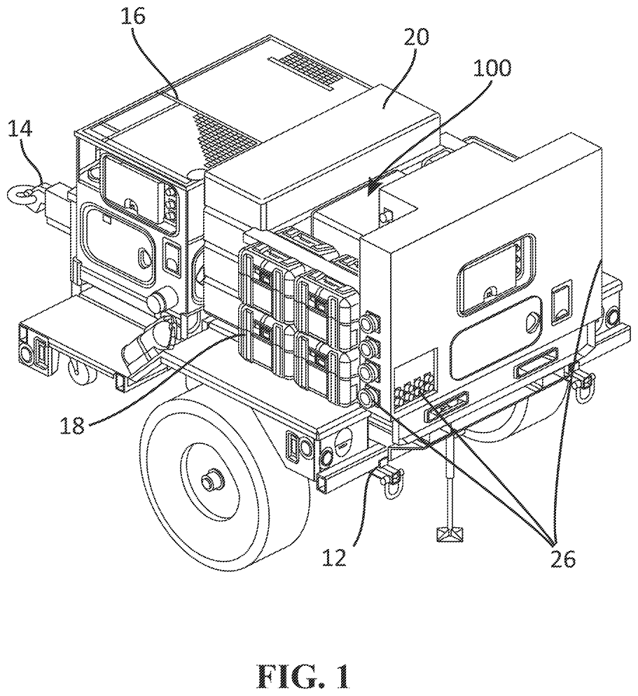

FIG. 1 illustrates a perspective view of a non-limiting example of a mobile power source system including an electronics packaging assembly 100, in accordance with some embodiments. For example, the example mobile power source system shown in FIG. 1 can be a mobile power source system (e.g., mobile power generator) configured to provide maintenance charging to a battery. The example mobile power source system shown in FIG. 1 includes the electronics packaging assembly 100 that is configured to convey electricity to one or more energy storage units (e.g., batteries) and/or one or more electrical loads, depending on the configurations. As described in greater detail below, the example mobile power source system shown in FIG. 1 includes a chassis 12 and a trailer 14. The mobile power source system can be coupled to the chassis 12 and/or the trailer 14 for further mobility. For example, the chassis 12 and/or the trailer 14 can be configured to move the mobile power source system from one location to another. The example mobile power source system shown in FIG. 1 can include a power source (e.g., a power generator 16 and a secondary power source 20) to be provided power. The example mobile power source system shown in FIG. 1 can include an energy storage system 18. The energy storage system 18 can include one or more batteries or any electrical components configured to store energy (e.g., a battery, a capacitor, etc.). The energy storage system 18 can optionally include a battery management system and one or more rechargeable batteries. The example mobile power source system shown in FIG. 1 can include a power distribution unit 26. The power distribution unit 26 is operatively coupled to, for example, the power generator 16, the energy storage system 18, and can be configured to distribute power to an external source (e.g., by providing electrical power, etc.).

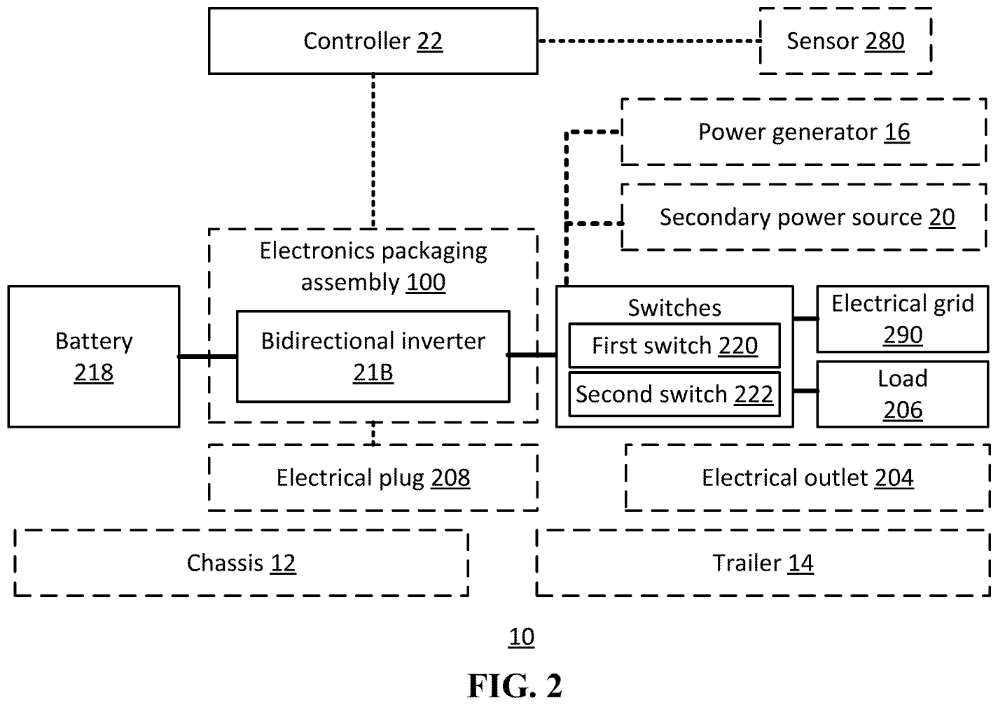

FIG. 2 illustrates a mobile power source system 10 that is configured to convey power to an energy storage system via maintenance charging using grid (or shore) power. The mobile power source system 10 includes a bidirectional inverter 21B, a controller 22, and switches including a first switch 220 and a second switch 222, and is configured to connect to an electrical grid 290 and a load 206 and provide power to a battery 218. The mobile power source system 10 can optionally include a chassis 12, a trailer 14, an electrical plug 208 configured to connect to an electrical outlet 204, an electronics packaging assembly configured to include the bidirectional inverter 21B. The controller 22 can be optionally configured to include or control a sensor 280. The mobile power source system 10 can be optionally configured to connect to a power source (a power generator 16 and a secondary power source 20) and be provided power.

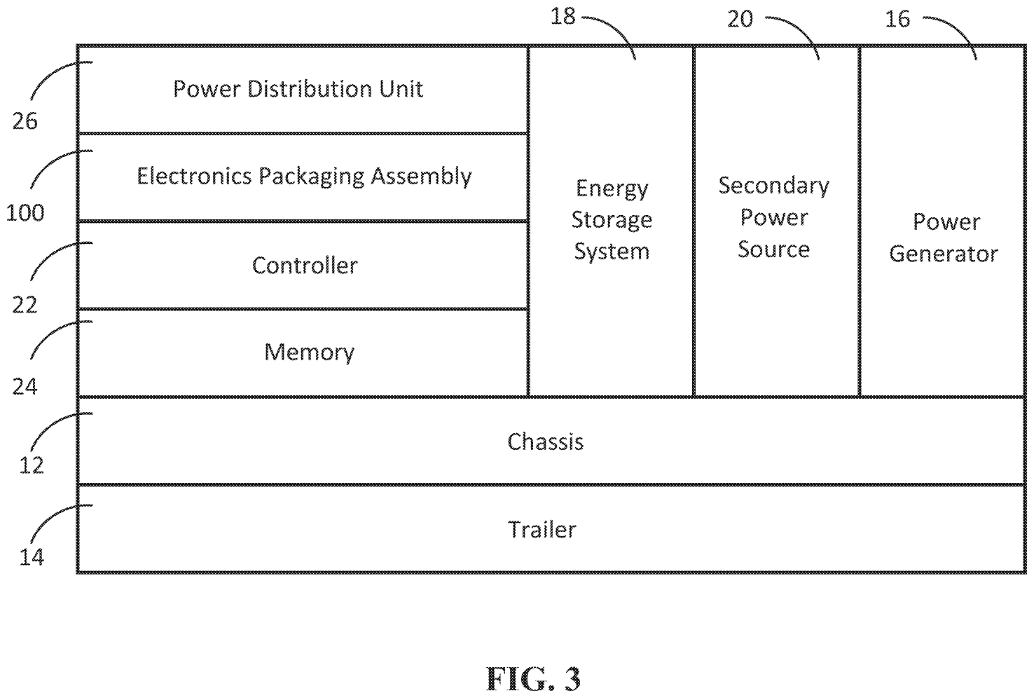

The mobile power source system 10 includes the bidirectional inverter 21B. The bidirectional inverter 21B is electrically connected to the battery 218 and configured to convert AC power to DC power in a first direction and convert DC power to AC power in a second direction. In some example, the mobile power source system 10 can optionally include the electronic packaging assembly 100, which can include the bidirectional inverter 21B. The bidirectional inverter 21B is configured to convert the grid power in a first direction and in a second direction. In some examples, a power distribution unit (e.g., 26 in FIG. 3) can optionally include the bidirectional inverter 21B electrically connected to the battery 218 and configured to convert AC power to DC power in a first direction and convert DC power to AC power in a second direction. For example, the first direction can be a direction for inversion. The second direction can be a direction for rectification. In some examples, the bidirectional inverter 21B can be optionally configured to facilitate power conversion from AC to DC and vice versa, e.g., DC to AC.

The mobile power source system 10 can optionally include the electronics packaging assembly 100. The electronics packaging assembly 100 is configured to facilitate heat transfer from the mobile power source system 10 and/or from electronic components housed within the electronics packaging assembly 100. In some embodiments, the electronics packaging assembly 100 includes a microgrid AMMPS bi-directional electronics (“MABEL”) system designed and made by Cummins, Inc. of Columbus, IN. The electronics packaging assembly 100 can be coupled (e.g., operatively coupled, electrically coupled, etc.) to, for example, the power distribution system via one or more contactors and/or connectors (not shown). The electronics packaging assembly 100 includes one or more electronic components including the bidirectional inverter 21B.

The mobile power source system 10 or at least a component thereof (e.g., the electronics packaging assembly 100) can be configured to operate under harsh environmental conditions (e.g., fluctuating temperatures, fluctuating humidity, rain, sand, dust, salt fog, etc.). For example, in some embodiments, the mobile power source system 10 or at least a component thereof (e.g., the electronics packaging assembly 100) has an operating temperature range from approximately −25° F. (approximately −31.7° C.) to 125° F. (approximately 51.7° C.), inclusive. For example, the mobile power source system 10 or at least a component thereof (e.g., the electronics packaging assembly 100) can operate at temperatures from −25° F. (approximately −31.7° C.) to 95° F. (approximately 35° C.), inclusive, at 4,000 feet above sea level, at all relative humidity with temperatures up to 125° F. (approximately 51.7° C.), inclusive, at sea level, and temperatures up to 95° F. (approximately 35° C.), inclusive, at altitudes ranging from 4,000 feet (approximately 1219 meters) to 10,000 feet (approximately 3048 meters). The mobile power source system 10 or at least a component thereof (e.g., the electronics packaging assembly 100) can operate below predetermined noise levels and mitigating electromagnetic interference. For example, in some embodiments, the mobile power source system 10 or at least a component thereof (e.g., the electronics packaging assembly 100) is configured to maintain a noise level below an audible threshold within an area extending approximately twenty meters, inclusive, away from and surrounding the mobile power source system 10. In some embodiments, the mobile power source system 10 or at least a component thereof (e.g., the electronics packaging assembly 100) is capable of mitigating EMI from electric fields over approximately 1 GHz. For example, the mobile power source system 10 or at least a component thereof (e.g., the electronics packaging assembly 100) is capable of mitigating EMI in the range from approximately 0.01 GHz to 0.1 GHz, 0.5 GHz, 0.75 GHz, 1 GHz, 1.5 GHz, etc.

In some embodiments, the mobile power source system 10 or at least a component thereof (e.g., the electronics packaging assembly 100) is configured to meet weight and volume constraints. For example, the mobile power source system 10 or at least a component thereof (e.g., the electronics packaging assembly 100) is configured to have an internal spatial volume sufficient for enclosing internal components while remaining mobile. Further, because operational conditions can vary, the weight and volume limits can be adjusted, respectively. Accordingly, in some embodiments, the mobile power source system 10 or at least a component thereof (e.g., the electronics packaging assembly 100) is configured to be scalable and modular. By being both scalable and modular, the mobile power source system 10 or at least a component thereof (e.g., the electronics packaging assembly 100) is capable of operating under a wider range of operational requirements.

The mobile power source system 10 includes the battery 218. The battery 218 is or can be included in an energy storage system (e.g., 18 in FIG. 3; batteries, capacitors, etc.). For example, the energy storage system can include a 24-volt DC battery, although embodiments are not limited thereto.

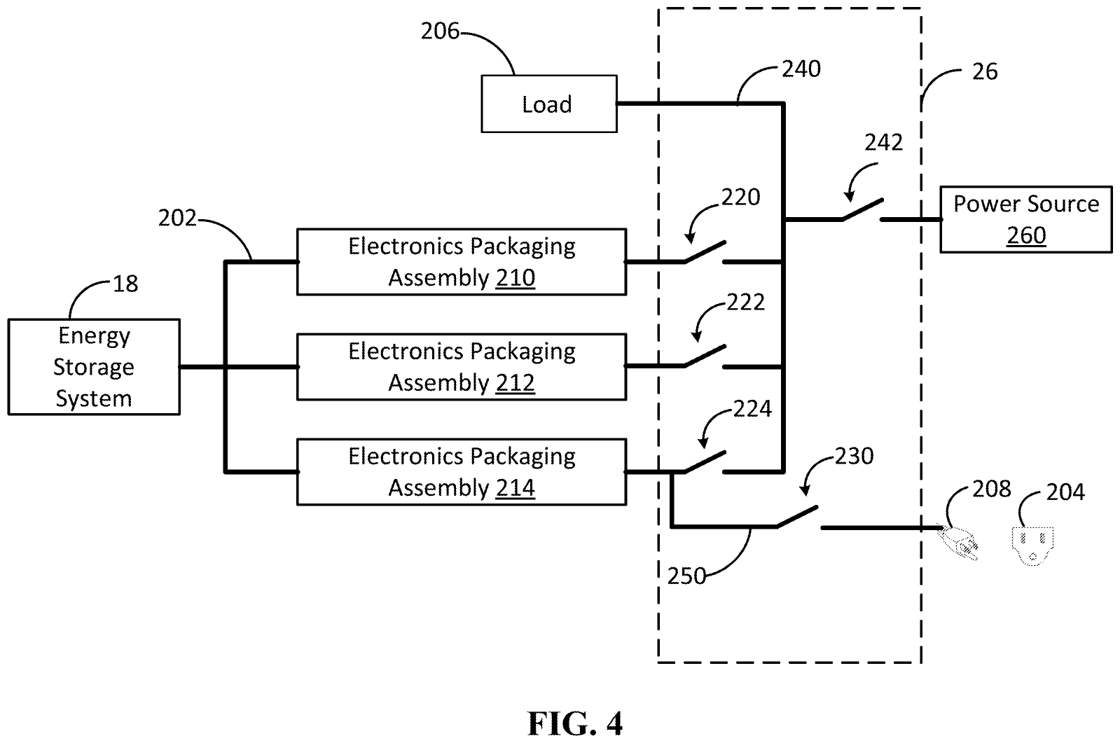

The mobile power source system 10 includes switches (e.g., a first switch 220 and a second switch 222). Although depicted in FIG. 2 with the first switch 220 and the second switch 222, the switches can include any number of switches (e.g., switches 220, 222, 224, 230, 242 in FIG. 4). In some examples, the first switch 220 can be configured to provide grid power from an electrical grid 290 to the bidirectional inverter 21B when switched on and stop providing the grid power to the bidirectional inverter 21B when switched off. In some examples, the second switch 222 can be configured to provide battery power from the bidirectional inverter 21B to the load 206 when switched on and stop providing the battery power to the load 206 when switched off. The mobile power source system 10 includes the controller 22 configured to control switches including the first switch 220 and the second switch 222.

The mobile power source system 10 includes a controller 22. The controller 22 includes one or more processors and is configured be integrated with or in communication with various electronic devices of the mobile power source system 10. For example, the controller 22 can include a personal computer, server system, and/or other computing device. In some embodiments, the various electronic components can contribute to any of the operations described herein and can be used to program the controller 22. In various embodiments, the controller 22 can include any type of processing circuitry. In some embodiments, the controller 22 can include one or more processors, a memory (not shown), and an input/output interface. In some embodiments, the controller 22 includes one or more processors, application-specific integrated circuits (ASICs), or circuity that is designed to cause or assist with the mobile power source system 10 or at least a component thereof (e.g., the electronics packaging assembly 100) in performing any of the steps, operations, processes, or methods described herein. In some embodiments, the controller 22 is configured to store executable instructions that are executable by any of the circuits, processors, or hardware components. In some embodiments, the controller 22 can optionally include or be connected to the electrical plug 208 configured to connect with the electrical outlet 204.

In some embodiments, the controller 22 can optionally include or be connected to a sensor 280. In some embodiments, the sensor 280 is configured to sense whether the electrical plug 208 (which can be optionally included) is receiving grid power when the electrical plug 208 is connected to the electrical outlet 204 (which can be optionally included). In some embodiments, the controller 22 can determine whether the shore (or grid) power is available, for example by, sensing at least one of a voltage, a current amount, or a frequency associated with the shore power when determining, by the controller 22, whether the shore power is available. For example, the sensor 280 can detect a voltage, a current amount, and/or a frequency (for AC power) of the current. The sensor 280 can detect whether the plug 208 is connected to the AC power outlet 204 and can provide feedback to the controller 22 which can use the sensed current to control the switches (e.g., switches in FIG. 2 and/or 220-224 and 230 in FIG. 4). In some implementations, the sensor output could be used to directly control at least one of the switches (e.g., switches in FIG. 2 and/or 220-224 and 230 in FIG. 4), rather than providing feedback to the controller 22 to control the switches. Further, the sensor 280 can be located outside of the electronics packaging assembly 100 and provide feedback to the controller 22. In some embodiments, when the sensor 280 detects the grid power, the controller 22 is configured to switch the first switch 220 on and switch the second switch 222 off. In some embodiments, the controller 22 is configured to prevent the load 206 from drawing power from the battery 218, for example by, based on a determination that the grid (or shore) power is available, preventing, by the controller 22, the load 206 from drawing power from the battery 218. For example, when the sensor 280 detects the grid (or shore) power, the controller 22 can control the first switch 220 and the second switch 222 to switch off such that the battery 218 is not drawing power to the load 206. In some embodiments, when the sensor 280 does not sense the grid power, the controller 22 is configured to switch the first switch 220 off and switch the second switch 222 on.

The mobile power source system 10 can be connected to a load 206. The load 206 can be provided power based on a status of the switches. For example, the controller 22 is configured to control the switches connected to a power source (e.g., 16, 20 as shown in FIG. 1, or 260 in FIG. 4) to provide power to the load 206.

The mobile power source system 10 can optionally include a secondary power source 20 (or sometimes referred to as a secondary power source, e.g., 20 in FIG. 3). The mobile power source system 10 can be configured to receive power from the secondary power source 20. The secondary power source 20 is a power source different from the power generator 16 and is configured to supply power to the mobile power source system 10. For example, the secondary power source 20 can include a renewable power source (e.g., a solar panel, a solar panel array, etc.). In some implementations, the secondary power source 20 can be integrated as a part of the mobile power source system 10 or coupled thereto. In some implementations, the secondary power source 20 can be a separate power source, and the mobile power source system 10 can include an interface to which the secondary power source 20 is configured to connect and through which power can be provided.

The mobile power source system 10 can optionally include a power generator 16. The mobile power source system 10 can include the power generator 16 configured to provide power to the battery 218 or the load 206. When the power generator 16 or the secondary power source 20 generates AC power, the power can be converted from AC to DC using the DC-AC inverter via rectification (e.g., second direction) and provide the DC power to the battery 218.

The power generator 16 is configured to provide power for operation of the mobile power source system 10. In some embodiments, the power generator 16 is an Advanced Medium Mobile Power Source (AMMPS). Further still, because the mobile power source system 10 is scalable and modular, the power generator 16 can be one of a 5 kilowatt (kW) AMMPS generator, a 10 kW AMMPS generator, or a 15 kW AMMPS generator. Although the above describes the mobile power source system 10 as having one power generator 16, the mobile power source system 10 is not so limited and can be configured to connect or be coupled to a power grid (e.g., a utility grid, microgrid, etc.) in parallel with one or more additional generators 16.

The mobile power source system 10 can optionally include an electrical outlet 204 (or sometimes referred to as AC power outlet). The electrical outlet 204 can provide grid (or shore) power from an electrical grid 290 or different power supply. In some embodiments, the electricity provided by the electrical outlet 204 can have an AC of approximately 120V at 60 Hz. However, embodiments are not limited thereto, and the electrical outlet 204 can provide power having different parameters. The grid (or shore) power can include any power being provided from an external power source that can be used while the power generator 16 and/or the secondary power source 20 and/or the battery 218 are not able to provide power to the load 206 or other electronic devices connected to the mobile power source system 10. For example, the grid (or shore) power can be provided from the electric grid 290, a generator, a secondary power source, a renewable energy source, a ship, a battery, or any other power source.

The mobile power source system 10 can optionally include a chassis 12 and a trailer 14. In some embodiments, the mobile power source system 10 is coupled to the chassis 12 and/or the trailer 14 for further mobility. For example, the mobile power source system 10 can include the chassis 12 and the trailer 14 configured to move the mobile power source system from one location to another.

Although the block diagram shows certain components, embodiments are not limited thereto, and there can be more or fewer components. Furthermore, the block diagram is intended to show at a high level some of the components of an example of the mobile power source system 10 and does not show the exact positions and/or sizes of the different components. Furthermore, certain components can be included in other components or integrated together. For example, the controller 22 can optionally include a memory (e.g., 24 in FIG. 3). For example, the electronics packaging assembly 100 can optionally include the controller 22 and/or the memory.

FIG. 3 illustrates a block diagram of an example of the mobile power source system 10, in accordance with some embodiments. As shown in FIG. 3, an example of the mobile power source system 10 can include the electronics packaging assembly 100, the controller 22, the chassis 12, the trailer 14, the secondary power source 20, and the power generator 16. The example mobile power source system can optionally include a power distribution unit 26, a memory 24, and an energy storage system 18.

In some embodiments, the memory 24 can include a non-transitory computable readable medium that is coupled to the processor of the controller 22 and stores one or more executable instructions that are configured to cause, when executed by the processor, the processor to perform or implement any of the steps, operations, processes, or methods described herein. The executable instructions can be of any type including applications, programs, services, tasks, scripts, libraries processes and/or firmware. The controller 22 can implement any logic, functions or instructions stored in the memory 24 to perform any of the operations described herein. In some embodiments, the controller 22 includes the memory 24. For example, the memory 24 (e.g., RAM, ROM, Flash Memory, hard disk storage, etc.) can store data and/or computer code for facilitating the various processes described herein. The memory 24 can be communicably connected to the processing circuitry to provide computer code or instructions for executing at least some of the processes described herein. The memory 24 can be or include tangible, non-transient volatile memory or non-volatile memory and can include database components, object code components, script components, or any other type of information structure for supporting the various activities and information structures described herein. Further, the executable instructions can be of any type including applications, programs, services, tasks, scripts, libraries processes and/or firmware. In some embodiments, the memory 24 can include a non-transitory computable readable medium that is coupled to the processor and stores one or more executable instructions that are configured to cause, when executed by the processor, the processor to perform or implement any of the steps, operations, processes, or methods described herein.

An example mobile power source system can include the power distribution unit 26 (e.g., an electrical system, etc.). The power distribution unit 26 is operatively coupled to, for example, the power generator 16, the energy storage system 18, the secondary power source 20, the controller 22, the memory 24, and the electronics packaging assembly 100, discussed in further detail below. In some embodiments, the power distribution unit 26 is configured to distribute power to an external source (e.g., by providing electrical power, etc.). The power distribution unit 26 can also be configured to distribute power to each of the components of the example mobile power source system. For example, in some embodiments, the power distribution unit 26 includes a high frequency direct current (HFDC) transformer (e.g., an isolation transformer, etc.) and a low voltage direct current (LVDC) power stage (e.g., a DC-DC LV power printed circuit board (PCB), etc.). In some embodiments, the power distribution unit 26 includes a high voltage direct current (HVDC) power stage and a DC-AC inverter.

An example mobile power source system can include the electronics packaging assembly 100. The electronics packaging assembly 100 can be optionally configured to facilitate heat transfer from the example mobile power source system and/or from electronic components housed within the electronics packaging assembly 100. In some embodiments, the electronics packaging assembly 100 includes a microgrid AMMPS bi-directional electronics (“MABEL”) system designed and made by Cummins, Inc. of Columbus, IN. The electronics packaging assembly 100 can be coupled (e.g., operatively coupled, electrically coupled, etc.) to, for example, the power distribution system via one or more contactors and/or connectors (not shown). The electronics packaging assembly 100 includes one or more electronic components including a bidirectional DC-AC inverter. For example, the example mobile power source system includes a first electronics packaging assembly (e.g., 100) that includes the bidirectional inverter (e.g., 21B).

Like the example mobile power source system, the electronics packaging assembly 100 can be configured to operate under harsh environmental conditions (e.g., fluctuating temperatures, fluctuating humidity, rain, sand, dust, salt fog, etc.). For example, in some embodiments, the electronics packaging assembly 100 has an operating temperature range from approximately −25° F. (approximately −31.7° C.) to 125° F. (approximately 51.7° C.), inclusive. For example, the electronics packaging assembly 100 can operate at temperatures from −25° F. (approximately −31.7° C.) to 95° F. (approximately 35° C.), inclusive, at 4,000 feet above sea level, at all relative humidity with temperatures up to 125° F. (approximately 51.7° C.), inclusive, at sea level, and temperatures up to 95° F. (approximately 35° C.), inclusive, at altitudes ranging from 4,000 feet (approximately 1219 meters) to 10,000 feet (approximately 3048 meters). The electronics packaging assembly 100 can operate below predetermined noise levels and mitigating electromagnetic interference. For example, in some embodiments, the electronics packaging assembly 100 is configured to maintain a noise level below an audible threshold within an area extending approximately twenty meters, inclusive, away from and surrounding the electronics packaging assembly 100. In some embodiments, the electronics packaging assembly 100 is capable of mitigating EMI from electric fields over approximately 1 GHz. For example, the electronics packaging assembly 100 is capable of mitigating EMI in the range from approximately 0.01 GHz to 0.1 GHz, 0.5 GHz, 0.75 GHz, 1 GHz, 1.5 GHz, etc.

In some embodiments, the electronics packaging assembly 100 is configured to meet weight and volume constraints. For example, the electronics packaging assembly 100 is configured to have an internal spatial volume sufficient for enclosing internal components while remaining mobile. Further, because operational conditions can vary, the weight and volume limits can be adjusted, respectively. Accordingly, in some embodiments, the electronics packaging assembly 100 is configured to be scalable and modular. By being both scalable and modular, the electronics packaging assembly 100 is capable of operating under a wider range of operational requirements.

Although the above description includes a discussion of components of the electronics compartment, the components are not so limited. In addition to the HVDC power stage and the DC-AC inverter, the electronics compartment can also include a load management system. The load management system is operatively coupled to the HVDC power stage and is configured to manage a load of the electronics compartment. In some embodiments, the electronics compartment includes a current sensor to manage the load. Further, in some embodiments, the electronics compartment includes HVDC link capacitors. The HVDC link capacitors are operatively coupled to each of the HVDC power stage and the DC-AC inverter. In some embodiments, the electronics compartment also includes an AC inductor-capacitor-inductor (LCL) filter assembly operatively coupled to the DC-AC inverter. Further, the AC LCL filter assembly can be operatively coupled to a harness (e.g., a wire harness, etc.).

An example mobile power source system can include the energy storage system 18. The energy storage system 18 can include one or more batteries (e.g., the battery 18) or any electrical components configured to store energy (e.g., a battery, a capacitor, etc.). The energy storage system 18 can optionally include a battery management system and one or more rechargeable batteries which are not shown for simplicity.

FIG. 4 illustrates a block diagram of a portion of an example of the mobile power source system 10, in accordance with some embodiments. The block diagram of the example mobile power source system shown in FIG. 4 is provided by way of example only, and there can be more or fewer components that are connected to any of the components shown in FIG. 4 in various implementations.

The example mobile power source system shown in FIG. 4 includes the energy storage system 18, the load 206, the electrical plug 208, the electrical outlet 204, and the electronics packaging assemblies 210, 212, 214. The example mobile power source system shown in FIG. 4 can include a controller area network (CAN) bus 202, a power source 260 and the power distribution unit 26 which includes switches 220, 222, 224, 230, 242 and cables 240, 250. In some examples, the energy storage system 18 can be or include one or more batteries (e.g., the batter 218). In some examples, the electronics packaging assemblies 210, 212, 214 can each be the electronics packaging assembly 100. In some examples, the power source 260 can be or include the power generator 16 and/or the secondary power source 20.

The load 206 can be connected to the cable 240 so that the example mobile power source system can provide power to the load 206. In some embodiments, the power source 260 can also include the electric grid or a micro-grid, and the power source 260 can also be provided with power from the energy storage system 18 (and/or the power generator 16 and/or the secondary power source 20).

The example mobile power source system is shown to include a power generator (e.g., 16) configured to provide power to the battery (e.g., 218, or the energy storage system 18) or the load 206. When a power generator (e.g., power generator 16) or a renewable power source (e.g., secondary power source 20) generates AC power, the power can be converted from AC to DC using the DC-AC inverter via rectification (e.g., second direction) and provide the DC power to the batteries in the energy storage system 18. In some embodiments, the example mobile power source system can include a renewable power source (e.g., as the secondary power source 20) configured to convert a renewable resource to renewable power and provide renewable power to the battery (e.g., 218, or the energy storage system 18) or the load 206.

The example mobile power source system shown in FIG. 4 can include three electronics packaging assemblies 210, 212, and 214 (e.g., electronics packaging assembly 100), but embodiments are not limited thereto, and there can be more or fewer electronics packaging assemblies connected together within the mobile power source system.

Each of the three electronics packaging assemblies 210, 212, 214 can include a bidirectional inverter (e.g., 21B, a bidirectional DC-AC inverter, etc.). For example, when a battery (e.g., battery in the energy storage system 18) is providing power to the load 206 that has an AC input, the power DC-AC inverter can invert the power from DC power from the battery to AC power for the load 206.

Multiple electronics packaging assemblies (e.g., such as the ones shown in FIG. 4) can be included in the mobile power source system so that larger generators and loads can be handled. For example, the controller 22 is configured to control the first electronics packaging assembly 210 configured to support a first amount of power and the second electronics packaging assembly 212 configured to support a second amount of power such that the mobile power source system supports a sum of the first amount of power and the second amount of power. For example, each of the electronics packaging assemblies 210, 212, 214 can support 5 kW of power (e.g., from the power generator 16 and/or the secondary power source 20 and/or energy storage system 18) such that the electronics packaging assemblies 210, 212, 214 combined can support 15 kW of power. Embodiments are not limited thereto, and additional electronics packaging assemblies can be added or removed.

In some embodiments, the controller (e.g., 22) of the example mobile power source system is configured to connect the first electronics packaging assembly (e.g., 210) and the second electronics packaging assembly (e.g., 212) via a network. For example, the electronics packaging assemblies 210, 212, 214 can be connected together by a controller area network (CAN) bus 202 which can be used to communicate with a respective controller of the other electronics packaging assemblies 210, 212, 214 as well as the battery management of the energy storage system 18.

The example mobile power source system can include the switches 220, 222, 224, 230, and 242 configured to be switched on (e.g., connected, closed-circuit) or switched off (e.g., disconnected, open-circuit), depending on what mode the example mobile power source system is in. In some embodiments, a controller (e.g., 22) of the mobile power source controller is configured to control the first electronic packaging assembly 210 to control a first switch (e.g., 220), control the second electronic packaging assembly 212 to control a second switch (e.g., 222), and control the third electronic packaging assembly 214 to control a third switch (e.g., 224). In some examples, the switches 220, 222, 224, 230, and 242 can include contactors and/or transistor(s) that can be electrically controlled by the controllers of the electronics packaging assemblies 210, 212, 214 to switch on or off. For example, the controller of the first electronic packaging assembly (e.g., 210) can control the first switch (e.g., 220), the controller of the second electronic packaging assembly (e.g., 212) can control the second switch (e.g., 222), and the controller of the third electronic packaging assembly (e.g., 214) can control the third switch (e.g., 224). The controller of the third electronics packaging assembly (e.g., 214) can also control the switch 230 as described below. In some embodiments, instead of the controllers of the electronics packaging assemblies 210, 212, 214, a different controller (e.g., controller 22) can control the switches 220, 222, 224, 230, and 242.

The power source 260 can provide power to the load 206 when the switch 242 is switched on. For example, a controller is configured to control the switch 242 connected to a power source (e.g., 260) to provide power to the load 206. Although not shown, there can be additional components (e.g., voltage regulator, rectifier, etc.) connected between the power source 260 and the load 206 that can regulate the current provided to the load 206. The power source 260 can also provide power to the energy storage system 18 when the switch 242 and one or more of the switches 220, 222, 224 are turned on, with appropriate conversion(s). For example, the power source 260 can invert the power from DC to AC which can be provided to the load 206 and/or the electronics packaging assemblies 210, 212, 214. The electronics packaging assemblies 210, 212, 214 can convert, using the bidirectional inverters (e.g., 21B) within the respective electronics packaging assemblies 210, 212, 214, the AC power back to DC power so that the power can be stored in the batteries (e.g., 218). In some embodiments, the power source 260 can generate DC power, which can be provided directly to the batteries of the energy storage system 18, without being converted from DC to AC and then again AC to DC.

When an example mobile power source system is in operation and being used to power the load 206, the load 206 can receive power from the energy storage system 18 via one or more of the electronics packaging assemblies 210, 212, 214, one or more of the switches 220, 222, 224, and cable 240, for example by relaying power from the energy storage system 18 (or the battery 218) to the load. For example, when the switch 220 is closed, the cable 240 can be connected to the electronics packaging assembly 210 which can relay power from one or more of the batteries from the energy storage system 18 to the load 206. Similarly, when the switch 222 and/or 224 is closed, the cable 240 can be connected to the electronics packaging assembly 212 and/or 214 which can relay power from the one or more of the batteries from the energy storage system 18 to the load 206. Furthermore, although not shown, the load 206 can receive power directly from the power source 260 (e.g., the generators 16 and/or the secondary power source 20 (e.g., renewable power source) without first storing the power to the batteries in the energy storage system 18, for example by directing power to the load 206 prior to storing the power in the battery.

The electrical outlet 204 can include grid (or shore) power which can provide approximately 120 V AC power at approximately 60 Hz. For example, the grid power can be provided from an existing electrical grid (e.g., 290 in FIG. 2) or a different power source. Although the examples in this disclosure refer to the grid power having 120 V, 60 Hz AC power, embodiments are not limited thereto, and the grid power can be configured for any type of AC output. For example, when the example mobile power source system is being stored or in transit in Australia, the grid power can have approximately 220 V AC power at approximately 50 Hz. An electrical plug 208 that connects to the AC power outlet 204 of the grid power source can be modified according to the standard of the geographic location where the example mobile power source system is being stored or in transit, as will be readily understood by one skilled in the art. In some examples, the electrical plug 208 can be configured to connect with the electrical outlet 204, and a sensor can be configured to sense whether the electrical plug 208 is receiving the grid power when the electrical plug 208 is connected to the electrical outlet 204.

The example mobile power source system can include the cable 250 with the plug 208 that can be connected to the electrical outlet 204 (e.g., AC power outlet). The sensor (e.g., 280 in FIG. 2) that is within a controller or connected to the controller of the electronics packaging assembly 214 can detect whether there is power being provided from the electrical outlet 204. For example, when the plug 208 is connected to the electrical outlet 204, the sensor in the electronics packaging assembly 214 can detect whether there is AC power available from the electrical outlet 204. Furthermore, when the sensor detects the AC power, the controller of the electronics packaging assembly 214 can close the switch 230 so that AC power is able to be drawn from the electrical outlet 204 through the cable 250. The switch 224 can be switched off by the controller of the electronics packaging assembly 214 when the grid (or shore) power from the electrical outlet 204 is being provided to the energy storage system 18. The electronics packaging assembly 214 can convert the AC power to DC power (or DC power to AC power) via a bidirectional inverter (e.g., DC-AC inverter, or bidirectional inverter/rectifier). Then the converted DC power can be provided to the energy storage system 18 where one or more batteries within the energy storage system 18 can be provided with grid power. Accordingly, the batteries in the energy storage system 18 can be charged with maintenance charging without any additional equipment.

In some embodiments, one or more of the switches 220, 222, 224, 230, and 242 can be switched and/or operated by a user. For example, when the user knows that the plug 208 is inserted into the outlet 204, or knows that the plug 208 will be inserted into the outlet 204, the user can switch on the switch 230 and switch off one or more of the switches 220, 222, 224, 230, and 242. Then the energy storage system 18 can receive maintenance charging. The user can also switch off the switch 230 and/or switch on one or more of the switches 220, 222, 224, 230, and 242 when the maintenance charging is complete (e.g., the example mobile power source system is generating power and/or providing power to the load 206). The user can use a controller (e.g., controller 22) to operate one or more of the switches 220, 222, 224, 230, and 242.

In operation, when the example mobile power source system is being stored (e.g., in a warehouse or secure facility) or in transit (e.g., on a ship), and/or for example, the battery is in storage or in transit, the mobile power source system has access to an AC power source via an outlet (e.g., via the electrical outlet 204), whether an electrical grid or power provided by the ship. An operator can plug the mobile power source system to the outlet so that maintenance charging can be provided to batteries (e.g., the battery 218, batteries in the energy storage system 18) in the mobile power source system. When the plug is plugged into the outlet, a first switch (e.g., switch 230) can be switched on (e.g., connected) to conduct electricity from the outlet to the batteries. A second switch can be switched off (e.g., disconnected) so that the batteries are not powering a load (e.g., 206) and the batteries are able to receive power for maintenance charging. The AC power from the outlet can be converted to DC power via rectification using a bidirectional inverter (e.g., the bidirectional inverter 21B in one of the electronics packaging assemblies 210, 212, 214). The DC power can be provided to the batteries. Accordingly, the batteries can remain in good health and full or near full charge without additional equipment for maintenance charging.

In some embodiments, the example mobile power source system can optionally include a mobile electric hybrid power source system (“MEHPS”) that can use and store renewable energy resources to operate under harsh environmental conditions (e.g., fluctuating temperatures including temperature extremes, fluctuating humidity, rain, sand, dust, salt fog, etc.). For example, a mobile power source controller is configured to operate under fluctuating temperatures ranging from −31.7° C. to 51.7° C. For example, in some embodiments, the mobile power source system 10 has an operating temperature range from approximately −25° F. (approximately −31.7° C.) to 125° F. (approximately 51.7° C.), inclusive. For example, the mobile power source system 10 can operate at temperatures from −25° F. (approximately −31.7° C.) to 95° F. (approximately 35° C.), inclusive, at approximately 4,000 feet (approximately 1219 meters) above sea level, at relative humidities with temperatures up to 125° F. (approximately 51.7° C.), inclusive, at sea level, and temperatures up to 95° F. (approximately 35° C.), inclusive, at altitudes ranging from 4,000 feet (approximately 1219 meters) to 10,000 feet (approximately 3048 meters).

The example mobile power source system can also optionally operate below predetermined noise levels. For example, the mobile power source controller is configured to operate below a predetermined noise level corresponding to an audible threshold. For example, in some embodiments, the mobile power source system is configured to maintain a noise level below an audible threshold within an area extending approximately twenty meters, inclusive, away from and surrounding the mobile power source system. In some embodiments, the mobile power source system is configured to mitigate electromagnetic interference (EMI). For example, the mobile power source system can be capable of mitigating EMI from electric fields over approximately 1 gigahertz (GHz). For example, the mobile power source system is capable of mitigating EMI in the range from approximately 0.01 GHz to 0.1 GHz, 0.5 GHz, 0.75 GHz, 1 GHz, 1.5 GHz, etc. In various implementations, the mobile power source system can be usable in military, construction, or other types of environments where, for example, the types of conditions described above can be present.

In addition to operating under harsh conditions, the example mobile power source system can meet weight and volume constraints. For example, the mobile power source system can be configured to have an internal spatial volume sufficient for enclosing internal components while remaining mobile (e.g., moveable, transportable, etc.). For example, the mobile power source system is configured to have an internal spatial volume to enclose the bidirectional inverter, the first switch, the second switch, and the controller. Further, because operational conditions can vary, the weight and volume limits can be adjusted, respectively. Accordingly, in some embodiments, the example mobile power source system is configured to be scalable and modular. By being both scalable and modular, the mobile power source system is capable of operating under a wider range of operational requirements.

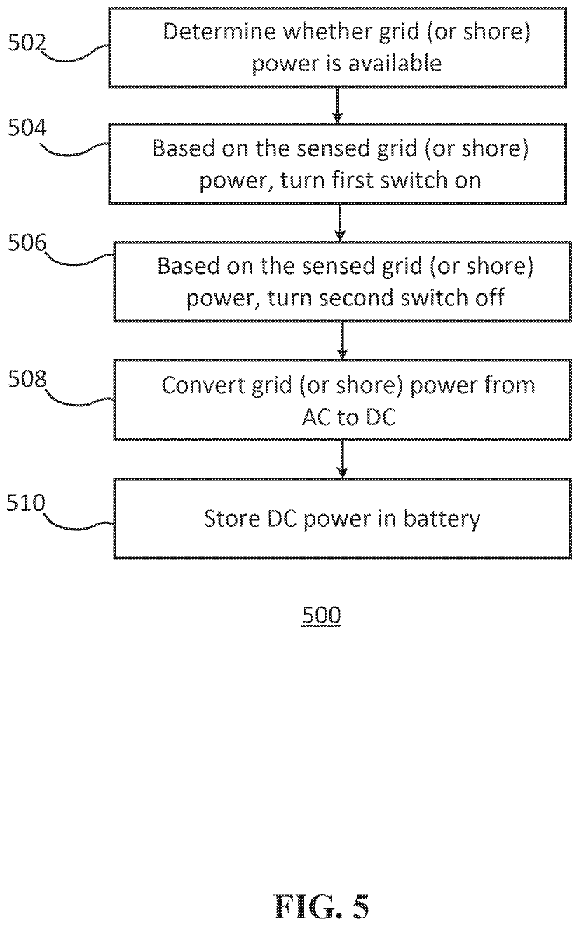

FIG. 5 illustrates a flowchart illustrating a method 500 (or process) of providing maintenance charging to a battery in the energy storage system 18, in accordance with some embodiments. The method 500 can be a mobile power source method of providing maintenance charging to a battery. The operations described below are exemplary and non-limiting, and include optional operations which can be omitted in some embodiments.

The method 500 includes determining, by a controller, whether shore power is available, based on a determination that the shore power is available, turning on, by the controller, a first switch connected to an outlet providing the shore power and a bidirectional inverter, based on a determination associated with availability of the shore power, turning off, by the controller, a second switch connected to the bidirectional inverter and the first switch, converting, by the bidirectional inverter, the shore power from alternating current (AC) power to direct current (DC) power, and storing, by the bidirectional inverter, the DC power in the battery.

In some embodiments, when the grid power is used, the method 500 can include determining, by a sensor, whether grid power is available, based on a determination associated with availability of the grid power, turning on, by a controller, a first switch, based on a determination associated with availability of the grid power, turning off, by the controller, a second switch, converting, by a bidirectional inverter, the grid power from AC power to DC power, and storing, by the bidirectional inverter, the DC power in the battery. In some embodiment, the grid power may be shore power.

One or more steps of the method 500 can be performed with a system or a component therein discussed above. For example, the method 500 can be performed by a mobile power source controller of a mobile power source system for providing maintenance charging to a battery. The mobile power source controller can include a processor configured to determine whether grid power is available, based on a determination associated with availability of the grid power, turn on a first switch connected to an outlet providing the grid power and a bidirectional inverter, based on a determination associated with availability of the grid power, turn off a second switch connected to the bidirectional AC-DC inverter and the first switch. convert the grid power from alternating current (AC) power to direct current (DC) power, and store the DC power in the battery.

Prior to the beginning the method 500, a first switch (e.g., switch 230) can be switched off and a second switch (e.g., switches 220, 222, 224, and/or 242) can be switched on. However, embodiments are not limited thereto, and the switches 220, 222, 224, 242, and 230 can be in any configuration.

The method 500 begins in step 502 by sensing, by a sensor, whether grid power is available. The step 502 can be or include sensing the presence of grid power from a plug (e.g., plug 208) that is plugged into an outlet (e.g., AC power outlet 204). The sensor can sense the current flowing through a cable (e.g., cable 250) connected to the plug. The grid power can be AC power.

The method 500 continues in step 504 by, based on the sensed grid power (or shore power), turning on, by controller, a first switch connected to an outlet providing the grid power and a bidirectional inverter. When the first switch is connected, the grid power can be provided to a bidirectional inverter (e.g., DC-AC inverter) of an electronics packaging assembly (e.g., electronics packaging assembly 100, 214) via the cable 250.

The method 500 continues in step 506 by, based on the sensed grid power (or shore power), turning off, by the controller, a second switch connected to the bidirectional AC-DC inverter and the first switch. When the first switch is switched off, the grid power is not provided to other components (e.g., electronics packaging assembly 210, 212, power source 260, etc.) or loads (e.g., load 206). For example, the grid power from the AC power outlet can be provided to the bidirectional inverter

The method 500 continues in step 408 by converting, by the bidirectional inverter, the grid power (or shore power) from AC power to DC power. The output of the bidirectional inverter can be connected to one or more batteries (e.g., one or more batteries in the energy storage system 18).

The method 500 continues in step 510 by storing, by the bidirectional inverter, the DC grid power to the battery.

In some embodiments, the method 500 can include performing the sensing (e.g., 502), turning on (e.g., 504), turning off (e.g., 506), converting (e.g., 508), and storing steps (e.g., 510) when the mobile power source system is in storage or in transit.

Accordingly, no additional equipment is required to provide maintenance charging to the batteries because the bidirectional inverter in the electronics packaging assembly can convert the AC power to DC power and charge up the batteries.

In one aspect, a mobile power source system configured to provide maintenance charging to a battery is disclosed. The mobile power source system includes a bidirectional inverter electrically connected to the battery and configured to convert an AC power to DC power in a first direction and convert DC power to AC power in a second direction, a first switch configured to provide grid power from an electrical grid to the bidirectional inverter when switched on and stop providing the grid power to the bidirectional inverter when switched off, a second switch configured to provide battery power from the bidirectional inverter to a load when switched on and stop providing the battery power to the load when switched off, and a controller configured to control the first switch and the second switch.

In some embodiments, the mobile power source system further includes an electrical plug configured to connect with an electrical outlet and a sensor configured to sense whether the electrical plug is receiving the grid power when the electrical plug is connected to the electrical outlet.

In some embodiments, when the sensor detects the grid power, the controller is configured to switch the first switch on and switch the second switch off.

In some embodiments, the mobile power source system further includes a first electronics packaging assembly that includes the bidirectional inverter, wherein the bidirectional inverter is configured to convert the grid power in the first direction.

In some embodiments, when the sensor does not sense the grid power, the controller is further configured to switch the first switch off and switch the second switch on.

In some embodiments, the mobile power source system further includes a power generator configured to provide power to the battery or the load.

In some embodiments, the mobile power source system further includes a renewable power source configured to convert a renewable resource to renewable power and provide renewable power to the battery or the load.

Another aspect is a method of providing maintenance charging to a battery of a mobile power source system when the battery is in storage or in transit. The method includes determining, by a sensor, whether grid power is available. The method further includes, based on a determination associated with availability of the grid power, turning on, by a controller, a first switch. The method further includes, based on a determination associated with availability of the grid power turning off, by the controller, a second switch. The method further includes converting, by a bidirectional inverter, the grid power from AC power to DC power. The method further includes relaying, by the bidirectional inverter, the DC power to the battery.

While this specification contains various implementation details, these should not be construed as limitations on the scope of what can be claimed but rather as descriptions of features specific to particular implementations. Certain features described in this specification in the context of separate implementations can also be implemented in combination in a single implementation. Conversely, various features described in the context of a single implementation can also be implemented in multiple implementations separately or in any suitable subcombination. Moreover, although features can be described as acting in certain combinations and even initially claimed as such, one or more features from a claimed combination can, in some cases, be excised from the combination, and the claimed combination can be directed to a subcombination or variation of a subcombination.

As utilized herein, the terms “substantially” and “generally,” and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of the appended claims.

The term “coupled” and the like, as used herein, mean the joining of two components directly or indirectly to one another. Such joining can be stationary (e.g., permanent) or moveable (e.g., removable or releasable). Such joining can be achieved with the two components or the two components and any additional intermediate components being integrally formed as a single unitary body with one another, with the two components, or with the two components and any additional intermediate components being attached to one another. For example, an air inlet and an air outlet are, in some embodiments, connectable via one or more intermediate conduit sections such that the air inlet and the air outlet are coupled together.

The terms “fluidly coupled to” and the like, as used herein, mean the two components or objects have a pathway formed between the two components or objects in which a fluid, such as air, reductant, an air-reductant mixture, coolant or other liquids and/or gasses, can flow, either with or without intervening components or objects. Examples of fluid couplings or configurations for enabling fluid communication can include piping, channel 130s, or any other suitable components for enabling the flow of a fluid from one component or object to another.

Also, the term “or” is used, in the context of a list of elements, in its inclusive sense (and not in its exclusive sense) so that when used to connect a list of elements, the term “or” means one, some, or all of the elements in the list. Conjunctive language such as the phrase “at least one of X, Y, and Z,” unless specifically stated otherwise, is otherwise understood with the context as used in general to convey that an item, term, etc. can be either X, Y, Z, X and Y, X and Z, Y and Z, or X, Y, and Z (i.e., any combination of X, Y, and Z). Thus, such conjunctive language is not generally intended to imply that certain embodiments require at least one of X, at least one of Y, and at least one of Z to each be present, unless otherwise indicated.

References herein to the positions of elements (e.g., “top,” “bottom,” “above,” “below”) are merely used to describe the orientation of various elements in the FIGURES. It should be noted that the orientation of various elements can differ according to other exemplary embodiments, and that such variations are intended to be encompassed by the present disclosure.

Additionally, the use of ranges of values herein are inclusive of their maximum values and minimum values unless otherwise indicated. The terms “about” or “approximately” in connection with a given numerical value encompass values within at least 5% of the stated value, including, e.g., 0.5%, 1% and 2.5% of the stated value.

It is important to note that the construction and arrangement of the various systems and the operations according to various techniques shown in the various example implementations is illustrative only and not restrictive in character. All changes and modifications that come within the spirit and/or scope of the described implementations are desired to be protected. It should be understood that some features can be omitted in certain embodiments whereas additional features can be present, and various modifications to any of the foregoing embodiments are feasible and fall within the scope of the disclosure, the scope being defined by the claims that follow.

1. A mobile power source system configured to provide maintenance charging to a battery, the system comprising:
a bidirectional inverter electrically connected to the battery and configured to convert an alternating current (AC) power to direct current (DC) power in a first direction and convert DC power to AC power in a second direction;
a first switch configured to provide grid power from an electrical grid to the bidirectional inverter when switched on and stop providing the grid power to the bidirectional inverter when switched off;
a second switch configured to provide battery power from the bidirectional inverter to a load when switched on and stop providing the battery power to the load when switched off; and
a controller configured to control the first switch and the second switch.

2. The mobile power source system of claim 1, further comprising:
an electrical plug configured to connect with an electrical outlet; and
a sensor configured to sense whether the electrical plug is receiving the grid power when the electrical plug is connected to the electrical outlet.

3. The mobile power source system of claim 2, wherein, when the sensor detects the grid power, the controller is configured to:
switch the first switch on; and
switch the second switch off.

4. The mobile power source system of claim 2, further comprising a first electronics packaging assembly that includes the bidirectional inverter, wherein the bidirectional inverter is configured to convert the grid power in the first direction.

5. The mobile power source system of claim 4, wherein, when the sensor does not sense the grid power, the controller is further configured to:
switch the first switch off; and
switch the second switch on.

6. The mobile power source system of claim 1, further comprising:
a power generator configured to provide power to the battery or the load.

7. The mobile power source system of claim 1, further comprising:
a renewable power source configured to convert a renewable resource to renewable power and provide the renewable power to the battery or the load.

8. The mobile power source system of claim 1, further comprising a chassis and a trailer configured to move the mobile power source system from one location to another.

9. The mobile power source system of claim 1, wherein the mobile power source system is configured to mitigate electromagnetic interference.

10. A method of providing maintenance charging to a battery of a mobile power source system, the method comprising:
determining, by a controller, whether shore power is available;
based on a determination that the shore power is available, turning on, by the controller, a first switch connected to an outlet providing the shore power and a bidirectional inverter;
based on a determination associated with availability of the shore power, turning off, by the controller, a second switch connected to the bidirectional inverter and the first switch;
converting, by the bidirectional inverter, the shore power from alternating current (AC) power to direct current (DC) power; and
storing, by the bidirectional inverter, the DC power in the battery.

11. The method of claim 10, further comprising:
based on a determination that the shore power is available, preventing, by the controller, a load from drawing power from the battery.

12. The method of claim 10, further comprising:
sensing at least one of a voltage, a current amount, or a frequency associated with the shore power when determining, by the controller, whether the shore power is available.

13. The method of claim 10, further comprising performing turning on, turning off, converting, and storing steps when the mobile power source system is in storage or in transit.

14. A controller of a mobile power source system for providing maintenance charging to a battery, the controller comprising a processor configured to:
determine whether grid power is available;
based on a determination associated with availability of the grid power, turn on a first switch connected to an outlet providing the grid power and a bidirectional inverter;
based on a determination associated with availability of the grid power, turn off a second switch connected to the bidirectional inverter and the first switch;
convert the grid power from alternating current (AC) power to direct current (DC) power; and
store the DC power in the battery.

15. The controller of claim 14, wherein the controller is configured to operate under fluctuating temperatures ranging from −31.7° C. to 51.7° C.

16. The controller of claim 14, wherein the controller is configured to operate below a predetermined noise level corresponding to an audible threshold.

17. The controller of claim 14, wherein the processor is configured to:
control a first electronics packaging assembly configured to support a first amount of power and a second electronics packaging assembly configured to support a second amount of power, such that the mobile power source system supports a sum of the first amount of power and the second amount of power.

18. The controller of claim 17, wherein the processor is configured to:
connect the first electronics packaging assembly and the second electronics packaging assembly via a network.

19. The controller of claim 14, wherein the processor is configured to:
control a first electronic packaging assembly to control the first switch;
control a second electronic packaging assembly to control the second switch; and
control a third electronic packaging assembly to control a third switch.

20. The controller of claim 14, wherein the processor is configured to:
control a switch connected to a power source to provide power to a load.
